(19) United States
(12) Patent Application Publication
(10) Pub. No.: US 2013/0329309 A1
(43) Pub. Date: Dec. 12, 2013

(54) MAGNIFYING GLASS WITH LIGHTING FUNCTION

(71) Applicants: Kuan-Di Huang, (US); Su-Shun Chen, (US)

(72) Inventor: Kuan-Di HUANG, New Taipei City (TW)

(73) Assignees: Su-Shun CHEN, New Taipei City (TW); Kuan-Di HUANG, New Taipei City (TW)

(21) Appl. No.: 13/649,325

(22) Filed: Oct. 11, 2012

(30) Foreign Application Priority Data
Jun. 8, 2012 (TW) 101211116

(51) Int. Cl. G02B 25/02

(52) U.S. Cl. 359/800

(57) ABSTRACT

The present invention is to provide a magnifying glass with a lighting function, which includes a housing having a front side formed with an objective aperture, a rear side formed with a viewing aperture which is opposite to and in communication with the objective aperture, and a fixing portion provided therein and facing the objective aperture; a plurality of light-emitting elements fixed to the fixing portion and able to emit visible light outward of the objective aperture; and a convex lens fixed to the housing at a position corresponding to the objective aperture and in front of the light-emitting elements. Thus, the visible light emitted by each light-emitting element is refracted by the convex lens and then projected onto the surface of an object to form a light projected area on the object, wherein the light projected areas overlap with one another to illuminate the surface of the object uniformly.

### FIELD OF THE INVENTION

The present invention relates to a magnifying glass with a lighting function, more particularly to a magnifying glass including a housing having a front side formed with an objective aperture, a plurality of light-emitting elements capable of emitting visible light outward of the objective aperture, and a convex lens fixed to the housing at a position corresponding to the objective aperture and in front of the light-emitting element, such that the visible light emitted by each light-emitting element is refracted by the convex lens and then projected onto the surface of an object to form a light projected area on the object, and the light projected areas overlap with one another to illuminate the surface of the object uniformly.

### BACKGROUND OF THE INVENTION

With the development of electronic technology, precision instruments of all kinds have been continuously improved. These precision instruments require highly precise operation, for maintenance for example, in which the components of the instruments are usually unidentifiable with the naked eye and must be handled with the assistance of auxiliary tools. One common example of such auxiliary tools is optical magnifying glasses, or magnifying glasses for short. To view an object (e.g., a precision instrument) with a magnifying glass, the object must be placed within the focal length of the magnifying glass so that a magnified virtual image can be generated to make the object more visible. Through the magnified virtual image, one can perform the intended operation such as maintenance work. However, as an ordinary magnifying glass cannot light up the object being viewed, a lack of light will hinder the viewer from clearly seeing the details of the object and consequently from performing the intended work, which makes the magnifying glass undesirable in practical use.

To solve the aforesaid problem, magnifying glasses equipped with light-emitting elements (hereinafter referred to simply as magnifying glasses) were developed, wherein the light-emitting elements can cast light on and hence increase the visibility of the objects being viewed, thereby facilitating the execution of intended operations, such as maintenance work. FIG. 1 shows a conventional magnifying glass 1 which includes a housing 10, a convex lens 11 and a plurality of light-emitting elements 12. The housing 10 is penetrated by a through hole 100 and is generally made of metal or plastic. The convex lens 11 is fixedly provided in the through hole 100 of the housing 10 and has an optical axis coinciding with the central axis of the through hole 100. In FIG. 1, the convex lens 11 is fixedly set in the housing 10, and the light-emitting elements 12 are fixed to the housing 10. An object can be viewed through the magnifying glass 1 from above the magnifying glass 1 (i.e., from above the convex lens 11 in FIG. 1). Compared with the convex lens 11, the light-emitting elements 12 are closer to the surface P of the underlying object being viewed. Therefore, the light emitted by the light-emitting elements 12 is projected directly onto the surface P of the object without being refracted by the convex lens 11.

Typically, light-emitting diodes (LEDs) are used as the light-emitting elements 12. Featuring high brightness, long service lives and small physical volumes, LEDs are perfect for use in handheld magnifying glass devices. The direction in which the light-emitting elements 12 emit light forms a specific included angle with the optical axis of the convex lens 11. As shown in FIG. 1, the light emitted by the light-emitting elements 12 is tilted slightly toward the center and thus illuminates a relatively small region. One can see the region illuminated by the light-emitting elements 12 through the convex lens 11. In FIG. 1, the light-emitting elements 12 project visible light onto the surface P of the object, and the visible light projected by each light-emitting element 12 forms a small light spot Q on the surface P of the object. As shown in FIG. 1, the light spots Q are separate from each other and do not overlap. It is these light spots Q that the viewer relies on as the lighting aid.

However, after years of observation and research, the inventor of the present invention has found the following. Referring to FIG. 1, although the separate light spots Q generated by the magnifying glass 1 do light up certain areas, some areas are left unilluminated by the light-emitting elements 12. Consequently, the surface P of the object is not uniformly illuminated, and the lighting effect in general leaves much to be desired. Now that the viewer can only see the few illuminated areas on the surface P of the object through the convex lens 11, the visibility of the object is poor, meaning the details of the object cannot be seen in full. Hence, not only is erroneous operation prone to happen, but also the viewer's eyes tend to fatigue after long-term use of the magnifying glass 1.

Therefore, the issue to be addressed by the present invention is to overcome the various drawbacks of the existing magnifying glasses or, more particularly, to arrange the light-emitting elements in such a way that the object being viewed can be uniformly illuminated, thereby effectively increasing the visibility of the object and protecting the viewer's eyes from fatigue.

### BRIEF SUMMARY OF THE INVENTION

It view of the aforementioned drawbacks of the conventional magnifying glasses, the inventor of the present invention conducted extensive research and experiment and finally succeeded in developing a magnifying glass with a lighting function as disclosed herein. It is hoped that, without incurring a significant increase in production costs, light-emitting elements can uniformly light up the object being viewed to increase the visibility thereof and prevent the viewer from erroneous operation or eye fatigue.

It is an object of the present invention to provide a magnifying glass with a lighting function, wherein the magnifying glass includes a housing, a plurality of light-emitting elements and a convex lens. The front side of the housing is formed with an objective aperture. The rear side of the housing is formed with a viewing aperture opposite the objective aperture. The viewing aperture is in communication with the objective aperture. A fixing portion is provided in the housing and faces the objective aperture. The light-emitting elements are fixed to the fixing portion and can emit visible light outward of the objective aperture. The convex lens is fixed to the housing and corresponds in position to the objective aperture. In addition, the convex lens is located in front of the light-emitting elements. Thus, the visible light emitted by each light-emitting element is refracted by the convex lens and then projected diffusely onto the surface of an object to form a light projected area on the object, wherein the light projected areas overlap with one another to illuminate the surface of the object uniformly. As the visible light emitted by the light-emitting elements is scattered by the convex lens and forms the overlapping light projected areas instead of separate light spots, non-uniform illumination is effectively prevented, and one who tries to view the object through the viewing aperture and the convex lens will be sufficiently assisted by the lighting of the light-emitting elements. Moreover, with the overlapping light projected areas substantially increasing the visibility of the object, the viewer is protected from eye fatigue and kept from erroneous operation.

Another object of the present invention is to provide the foregoing magnifying glass, wherein the magnifying glass further includes a switching element and a battery. The light-emitting elements are connected to the switching element and the battery. The battery provides the power required by the light-emitting elements to emit visible light, and the switching element is configured for switching the power provided by the battery to the light-emitting elements.

Still another object of the present invention is to provide the foregoing magnifying glass, wherein the magnifying glass further includes a light-permeable plate fixed to the housing and corresponding in position to the viewing aperture. Thus, the inner side of the convex lens is protected from grime which may otherwise build up if dust is allowed to enter the housing through the viewing aperture.

### BRIEF DESCRIPTION OF THE SEVERAL VIEWS OF THE DRAWINGS

The structure as well as a preferred mode of use, further objects and advantages of the present invention will be best understood by referring to the following detailed description of some illustrative embodiments in conjunction with the accompanying drawings, in which:

FIG. 1 is a schematic sectional view of a conventional magnifying glass with light-emitting elements;

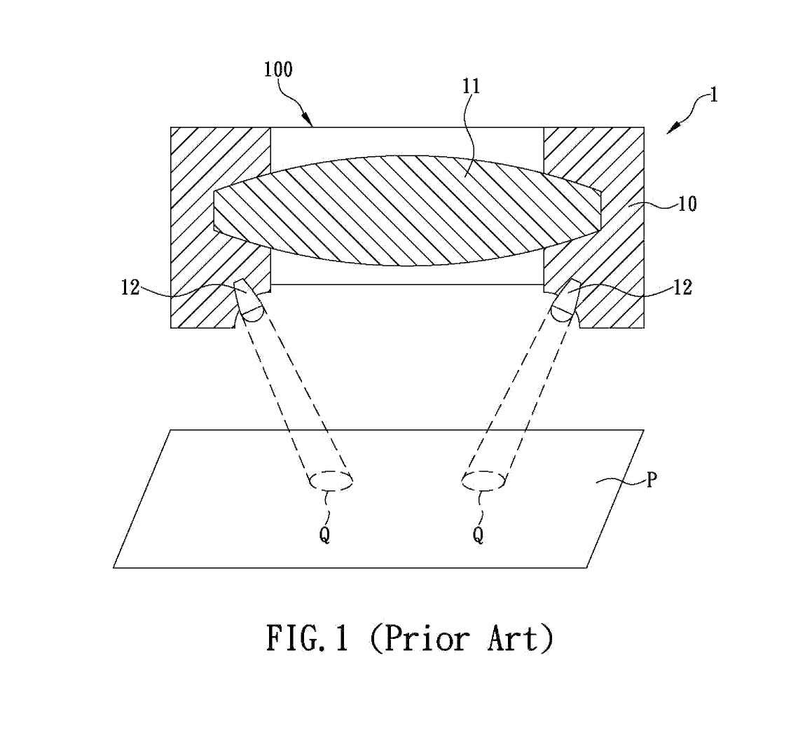

FIG. 2 is a perspective view of a preferred embodiment of the present invention;

FIG. 3 is a schematic sectional view of the preferred embodiment of the present invention; and

FIG. 4 is a schematic structural diagram of the preferred embodiment of the present invention.

### DETAILED DESCRIPTION OF THE INVENTION

The inventor of the present invention has long been engaged in the research and development of magnifying glasses and like optical instruments. In the process, the inventor has found that the existing magnifying glasses with light-emitting elements can only light up some areas of the object being viewed while leaving other areas unilluminated. Based on the inventor's observation, the cause of this non-uniform illumination is that the light-emitting elements of a conventional magnifying glass can only project small light spots on the surface of the object being viewed. Since the light is not shone over the surface of the object in a diffused manner, the viewer does not receive full assistance from the lighting of the light-emitting elements, and the viewer's eyes may fatigue as a result. While attempts have been made to improve the conventional magnifying glasses, with a view to overcoming the aforesaid problems, an ideal solution has yet to be found. In consideration of this, the inventor came up with the idea of rearranging the convex lens and the light-emitting elements, so as for the light emitted by the light-emitting elements to shine diffusely on the surface of the object being viewed. Thus, uniform illumination can be achieved, and the visibility of the object, increased.

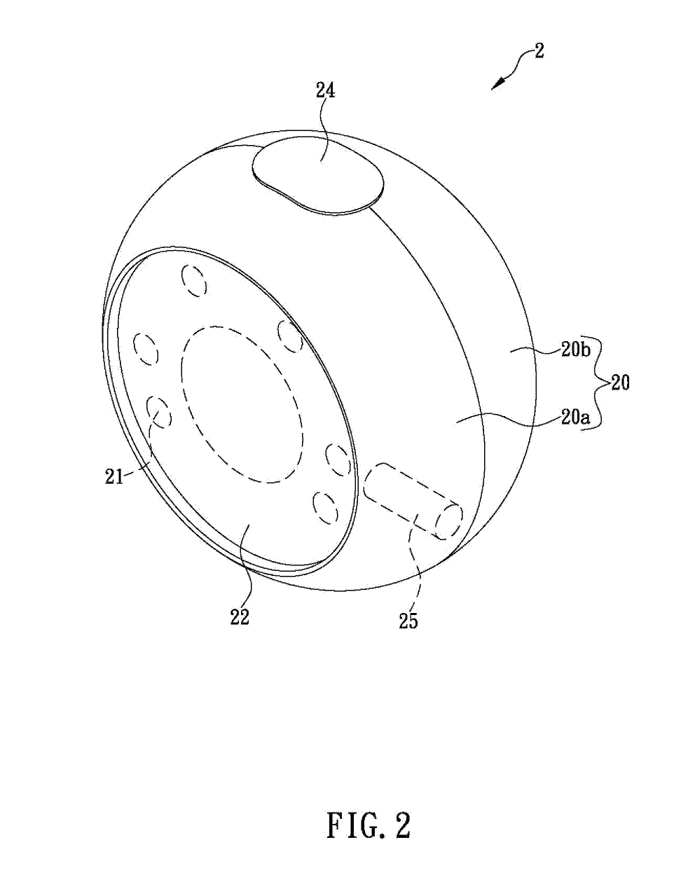

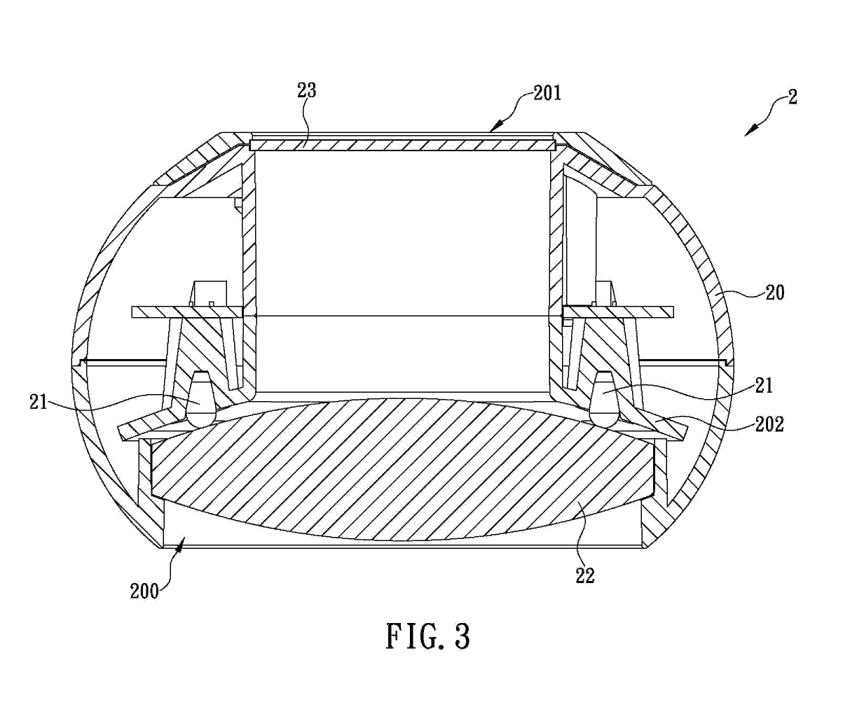

The present invention discloses a magnifying glass with a lighting function. Referring to FIG. 2 for a preferred embodiment of the present invention, the magnifying glass 2 includes a housing 20, a plurality of light-emitting elements 21 and a convex lens 22. Referring to FIG. 3, the front side (i.e., the lower side as shown in FIG. 3) of the housing 20 is formed with an objective aperture 200, and the rear side (i.e., the upper side as shown in FIG. 3) of the housing 20 is formed with a viewing aperture 201 opposite the objective aperture 200. The viewing aperture 201 is in communication with the objective aperture 200. The magnifying glass 2 further includes a light-permeable plate 23. The light-permeable plate 23 is fixed to the housing 20 and corresponds in position to the viewing aperture 201 to prevent dust from entering the housing 20 and thereby prevent the build-up of grime on the inner side of the convex lens 22.

Referring again to FIG. 3, in the preferred embodiment of the present invention, the housing 20 is provided therein with a fixing portion 202 facing the objective aperture 200. The light-emitting elements 21 are fixed to the fixing portion 202 and can emit visible light outward of the objective aperture 200. In practice, the housing 20 can be made by plastic injection molding, and yet the present invention imposes no limitations in this regard. A manufacturer wishing the produce the housing 20 of the present invention may change the material and manufacturing method of the housing 20 according to product or manufacturing process requirements. As shown in FIG. 2, six light-emitting elements 21 are used in this preferred embodiment, but the number of the light-emitting elements 21 is by no means limited to six and may be increased or decreased according to the brightness of the light-emitting elements 21 and the use of the magnifying glass 2. All variations and modifications easily conceivable by a person skilled in the art should fall within the scope of the present invention. Referring back to FIG. 3, the convex lens 22 is fixed to the housing 20 and corresponds in position to the objective aperture 200. In addition, the convex lens 22 is located in front of the light-emitting elements 21 (i.e., below the light-emitting elements 21 as shown in FIG. 3).

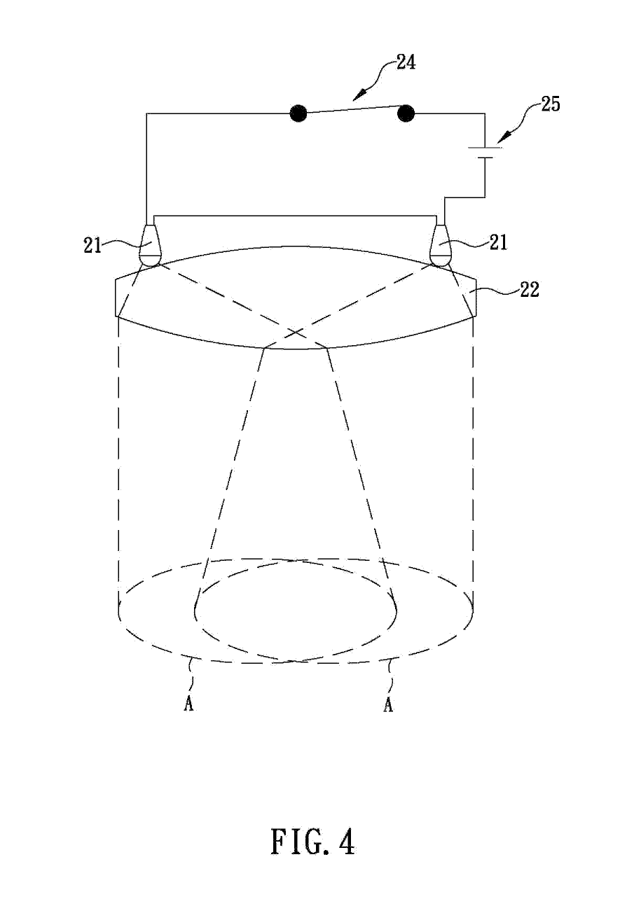

Please refer to FIG. 4 for a schematic structural diagram of the preferred embodiment of the present invention. As shown in the drawing, each light-emitting element 21 is connected to a switching element 24 and a battery 25. Referring to FIG. 2, the switching element 24 is provided in the housing 20, and one end of the switching element 24 is exposed from the housing 20 so as to be pressed by the user for switching purposes. The battery 25 can be a common zinc-carbon battery or lithium battery but is not limited thereto. Also, the housing 20 can be designed as a combination of a front housing member 20a and a rear housing member 20b (as shown in FIG. 2), and the switching element can be designed as linked to the front housing member 20a and the rear housing member 20b so that the switching element is switchable by turning the front and the rear housing members 20a and 20b. The battery 25 provides the power required by the light-emitting elements 21 to emit visible light. The switching element 24 is configured for switching the power provided by the battery 25 to the light-emitting elements 21. The visible light emitted by each light-emitting element 21 is refracted by the convex lens 22 and then projected diffusely unto the surface of an object (e.g., a precision instrument not shown), thus forming a light projected area A on the object. Due to the light converging property of the convex lens 22, the light emitted divergently from each light-emitting element 21 is slightly converged after refraction by the convex lens 22 and will form the light projected area A as shown in FIG. 4. More importantly, the light projected areas A overlap with one another to illuminate the surface of the object uniformly.

Referring to FIGS. 3 and 4, the technical features of the present invention are such that the visible light emitted by the light-emitting elements 21 does not form separate light spots but is diffused by the convex lens 22, forming the overlapping light projected areas A. Thus, non-uniform illumination by the light-emitting elements 21 is effectively prevented, and one who tries to view the object through the viewing aperture 201 and the convex lens 22 will be fully assisted by the lighting of the light-emitting elements 21. Now that the overlapping light projected areas A can increase the visibility of the object substantially, the viewer not only is less subject to eye fatigue but also is prevented from erroneous operation.

While the invention herein disclosed has been described by means of specific embodiments, numerous modifications and variations could be made thereto by those skilled in the art without departing from the scope of the invention set forth in the claims.

What is claimed is:

1. A magnifying glass with a lighting function, comprising:
a housing having a front side formed with an objective aperture and a rear side formed with a viewing aperture opposite and in communication with the objective aperture, the housing being provided therein with a fixing portion facing the objective aperture;
a plurality of light-emitting elements fixed to the fixing portion and configured for emitting visible light outward of the objective aperture; and
a convex lens fixed to the housing and corresponding in position to the objective aperture, the convex lens being located in front of the light-emitting element such that the visible light emitted by each said light-emitting element is refracted by the convex lens and then projected diffusely unto a surface of an object to form a light projected area on the object, wherein the light projected areas overlap with one another.

2. The magnifying glass of claim 1, further comprising a battery provided in the housing, wherein the battery is connected to the light-emitting elements so as to provide power thereto and thereby enable the light-emitting elements to emit the visible light.

3. The magnifying glass of claim 2, further comprising a switching element provided in the housing, the battery being separately connected to the switching element and the light-emitting elements, the switching element being configured for switching the power provided by the battery to the light-emitting elements.

4. The magnifying glass of claim 3, wherein the switching element has an end exposed from the housing and configured to be pressed by a user for switching purposes.

5. The magnifying glass of claim 4, further comprising a light-permeable plate fixed to the housing and corresponding in position to the viewing aperture.
